(19) United States
(12) Patent Application Publication
(10) Pub. No.: US 2005/0277316 A1
(43) Pub. Date: Dec. 15, 2005

(54) Portable memory device having a carabiner

(75) Inventor: Adam Cohen, North Salem, NY (US)

Correspondence Address: FRISHAUF, HOLTZ, GOODMAN & CHICK, PC, 220 5TH AVE FL 16, NEW YORK, NY, 10001-7708, US

(73) Assignee: Pencoa Corporation, Westbury, NY (US)

(21) Appl. No.: 10/868,439

(22) Filed: Jun. 14, 2004

(51) Int. Cl. H01R 13/44

(52) U.S. Cl. 439/135

(57) ABSTRACT

A portable electronic storage device with an internal memory device includes a base, a memory device arranged in connection with the base, an adapter connected to the memory device, a cover detachably connected to the base and a clip arranged on the base or cover for enabling the base or cover to be removably clipped to an object. The adapter is arranged on the base such that when the cover is detached from the base, the adapter is exposed and can be coupled to an I/O port of a computer and when the cover is connected to the base, the adapter is covered by the cover thereby preventing damage to the adapter and memory device.

### FIELD OF THE INVENTION

The present invention relates generally to a portable memory device and more particularly to a portable memory device that can be removably clipped onto a garment, knapsack or other object.

The present invention also relates generally to a carabiner with an internal memory device that can be clipped onto a garment, knapsack or other object and more particularly, to a carabiner with an internal USB-compatible memory stick.

### BACKGROUND OF THE INVENTION

Nowadays, with the proliferation of computer and other electronic devices, people are able to utilize computers and the other electronic devices at various locations in the normal course of their activities, i.e., at home, at work, at a restaurant or coffee shop. However, if a person desires to retrieve a stored file or create and save a file for later use, they must carry a data storage device, such as a diskette, CD-ROM or flash memory stick, with them, e.g., in their pocket. This arrangement is problematic because the disc storage device is susceptible to damage if it is carried improperly and can be lost or misplaced because it doesn't include a device to properly secure the data storage device to the person or an object the person is carrrying.

Accordingly, it would be advantageous to provide a device which enables a person to store and transport data by securely attaching the device to the user or an object the user is carrying, but does not interfere with usual daily activities.

### OBJECTS AND SUMMARY OF THE INVENTION

Accordingly, it is an object of the present invention to provide a portable memory device having a carabiner with an internal data storage device which is versatile and easy to use.

It is another object of the present invention to provide a portable memory device having a carabiner with an internal storage device which is USB-compatible.

It is yet another object of the present invention to provide a portable memory device that can be securely attached to a person's garment in a manner that it cannot be lost or misplaced, and it does not interfere with the person's usual daily activities.

In order to achieve these objects and others, a portable memory device having a carabiner in accordance with the invention includes a base, a memory device arranged in connection with the base, an adapter connected to the memory device, a cover detachably connected to the base and a clip arranged on the base or cover for enabling the base or cover to be removably clipped to an object. The adapter is arranged on the base such that when the cover is detached from the base, the adapter is exposed and can be coupled to an I/O port of a computer or other electronic device and when the cover is connected to the base, the adapter is concealed by the cover thereby preventing damage to the adapter and memory device.

By providing a memory device in combination with a carabiner, a person is able to store data in a personal and portable memory device which can be used wherever the individual finds himself. He can use it at home before departing for work as well as at work by connecting it to a laptop or other type of portable computing device. He can also use it to transport digital pictures shot at a party or when visiting with friends.

In one embodiment, to securely mate the cover with the base, one or more sets of a complementary ridge and groove are formed on the cover and base, in alignment with one another when the cover and base are properly positioned relative to one another. As such, unintentional detachment of the cover from the base is hindered, ensuring the adapter and memory device are protected against the elements.

In some embodiments, the adapter projects outward from an edge of a main body of the base while the cover includes a cavity receivable of the adapter. A mounting rim might be provided projecting from an edge of the main body with the adapter projecting from an edge of the mounting rim. In this case, the cavity includes an interior ledge to provide the cavity with a first, wider portion receivable of the mounting rim and a second, narrower portion receivable of the adapter. One or more sets of the complementary ridge and groove can be arranged on the mounting rim and on the inner surface of the cover defining the first, wider portion of the cavity.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a top plan view of a first embodiment of a carabiner in accordance with the invention.

FIG. 2 is a left side elevational view of the carabiner shown in FIG. 1;

FIG. 3 is a left side exploded view of the carabiner shown in FIG. 1.

FIG. 4 is a end elevational view of the base and collector portion of the carabiner shown in FIG. 1 as seen along line 4-4 in FIG. 3.

FIG. 5 is a end elevational view of the cover portion of the carabiner shown in FIG. 1 as seen along line 5-5 in FIG. 3.

FIG. 6 is a top plan view of a second embodiment of a carabiner in accordance with the invention.

FIG. 7 is a left side elevational view of the carabiner shown in FIG. 6;

FIG. 8 is a left side exploded view of the carabiner shown in FIG. 6.

FIG. 9 is a left side exploded view of a third embodiment of a carabiner in accordance with the invention.

### DETAILED DESCRIPTION OF THE PREFERRED EMBODIMENTS

Referring to the accompanying drawings wherein like reference numbers refer to the same or similar elements, a first embodiment of an electronic storage device including a carabiner in accordance with the invention is designated generally as 10 and comprises a base 12 and a cover 14 detachably connected to the base 12. A suitable engagement mechanism for mating the base 12 and cover 14 is provided to prevent separation of the base 12 from the cover 14 in the absence of a force above a predetermined threshold, i.e., the cover 14 will remain engaged to the base 12 unless a person intentionally separates the base 12 from the cover 14. Such a mechanism might constitute a design of the base 12 and cover 14 to mate with a friction fit. Other suitable connectors include a ridge on the base operatively engageable with a groove or indented portion on the interior of the core.

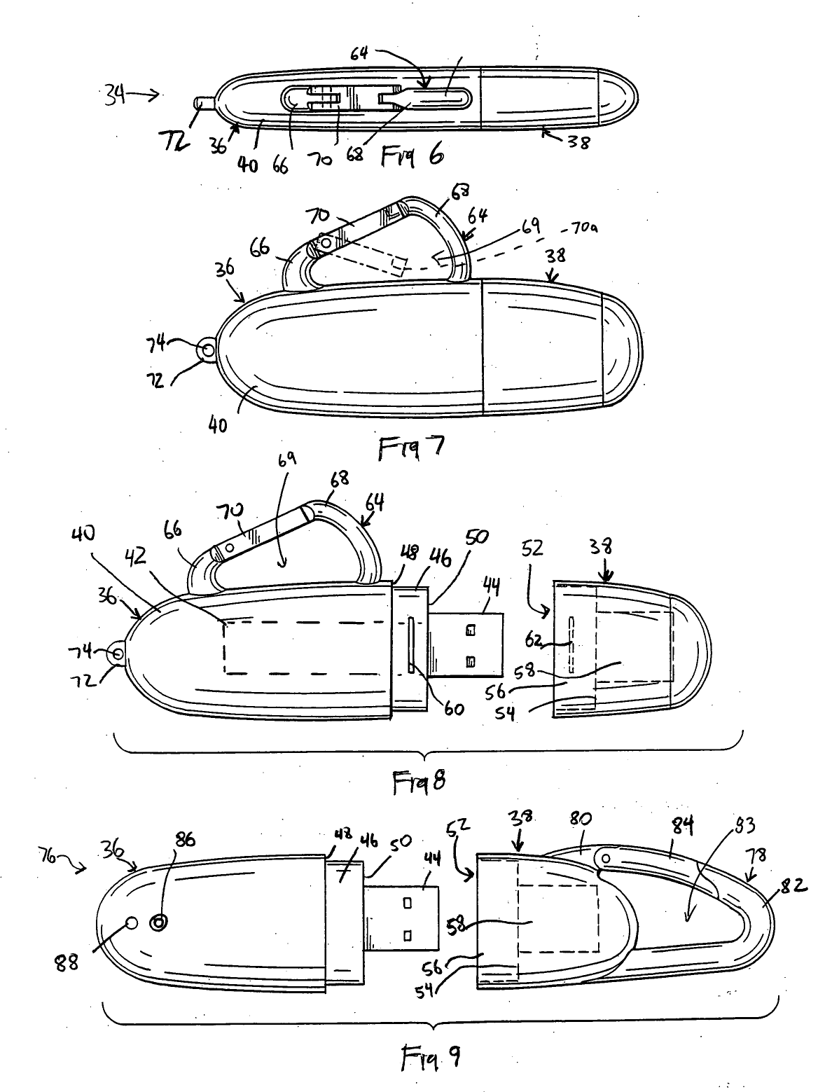

The base 12 includes a main body 16, an internal memory or data storage device 18 internally disposed in the main body 16 and an adapter 20 operatively coupled to the memory device 18 as known in the art. Adapter 20 is designed to operatively couple the memory device 18 to an I/O port of a computer or other electronic device such as a hand-held personal organizer, digital camera, or mobile telephone. The adapter 20, and possibly also part of the memory device 18, projects from an edge 22 of the body 16 and is received in a cavity 24 formed in the cover 14 (see FIGS. 3 and 5).

In one embodiment, the adapter 20 can be in the form of a USB connector which operatively couples the memory device 18 to a USB port of a laptop or desktop computer. Other types of connectors could be employed. The dimensional requirements of such a USB adapter are known to those skilled in the art. The storage capacity of the memory device 18, which may be, for example, a Compact Flash™, Memory Stick™, Memory Stick Pro™, SmartMedia™, x-D Picture Card™, SD™ or MultiMedia Card™, among others, can be 16 MB, 32 MB, 64 MB, 128 MB, 256 MB, or 512 MB or otherwise depending on the size of the main body 16 of the carabiner 10 and the size of the memory device 18.

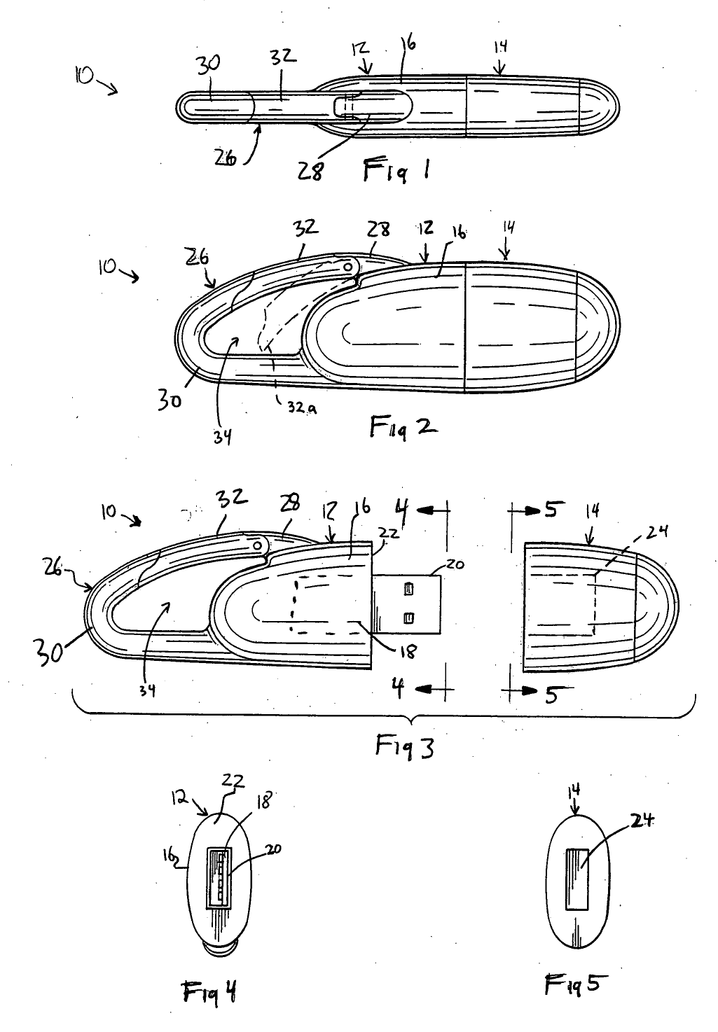

In accordance with this embodiment of the invention, the base 12 also includes a clip 26 formed by a pair of projections 28, 30 projecting from the main body 16 and arranged to define an opening 34 therebetween, and a latching member 32 which is pivotally attached to an end of projection 28 defining the opening and biased to engage with the end of the other projection 30 defining the opening. The latching member 32 can be depressed inward to enable access to an interior region of the carabiner 10 through the opening (as shown by the dotted lines 32a in FIG. 2) and thereby allow the carabiner 10 to be clipped or hooked onto a belt loop or another loop of material on a garment or object. The projections 28, 30 of the clip 26 can be integrally formed with the body 16 or formed separately and fixed thereto. Other constructions of projections and latching members known in the carabiner art can also be used in the invention. While it is described that the latching member is pivotally attached to an end of projection 28, it is foreseen that the latching member 32 could also be pivotally attached to projection 30 and biased to engage with the end of projection 28. In addition, while it is described that latching member 32 is depressed inward to enable access to the interior region of the carabiner, it is foreseen that latching member 32 could be constructed to open outward or sideways to enable access to the interior region of the carabiner.

With the integral memory device 18 and adapter 20, the electronic storage device including a carabiner 10 could be used to store and transfer data, e.g., in the form of data files. Specifically, a user would be able to access a computer or other electronic device at one location and couple the memory device 18 to the computer via the adapter 20 in order to access the memory device 18. The user could retrieve files from and/or save files to the memory device 18. When the user finishes working on the file or creating a new file, the user would save the file to the memory device 18 and disengage the adapter 20 from the computer. The user would then engage the cover 14 with the base 12 to enclose the adapter 20 and prevent damage to the memory device 18 and adapter 20. The carabiner 10 could be attached to a belt loop on the pants of the user or onto the user's knapsack by depressing the latching member 32 inward and slipping the belt loop or strap of the knapsack between the opening 34 defined by the projections 28 and 30, and the latching member 32. When the user arrives at another location, or even returns to the same location, the carabiner is unclipped from the belt loop or knapsack strap and the adapter 20 could be coupled to a computer to access and retrieve the stored file for downloading further modifications.

The use of a carabiner to attach the electronic storage device is an extremely secure means to transport the electronic storage device without the concern that the device could become unattached and enables a user to securely transport the device without having to place the memory device in the user's pocket or bag where the device could become damaged.

FIGS. 6-8 show another embodiment of an electronic storage device including a carabiner 34 in accordance with the invention which comprises a base 36 and a cover 38 detachably connected to the base 36. The base 36 includes a main body 40, an internal memory or data storage device 42 arranged in the body 40 and an adapter 44 operatively coupled to the memory device 42. Base 36 also includes a mounting rim 46 projecting from an edge 48 of the body 40 (see FIG. 8). Adapter 44, and possibly also part of the memory device 42, projects from an edge 50 of the mounting rim 46.

To accommodate the mounting rim 46 and the adapter 44, the cover 38 includes a cavity 52 having an interior ledge 54 to thereby provide the cavity 52 with a shape which is complementary to the shape of mounting rim 46 and adapter 44 (see FIG. 8). Thus, the cavity 52 includes a first portion 56 receivable of the mounting rim 46 and a second portion 58 receivable of the adapter 44.

To securely engage the base 36 and cover 38, one or more grooves 60 are provided on the mounting rim 46 and one or more complementary ridges 62 are provided on the inner surface of the cover 38 defining the cavity 52. Each ridge 62 is designed to align with a respective groove 60 when the cover 38 is properly engaged with the base 36 so that the ridge 62 is received in the groove 60 and thereby prevents separation of the base 36 from the cover 38 in the absence of a force above a predetermined threshold, i.e., the cover 38 will remain engaged to the base 36 unless a person forcefully and intentionally separates the base 36 from the cover 38. Instead of forming the groove(s) 60 on the mounting rim 46 and the ridge(s) 62 on the inside surface of the cover 38 defining the cavity portion 56, it is envisioned that the grooves could be formed on the inside surface of the cover 38 defining the cavity portion 56 and the ridges on the mounting rim 46. These engagement mechanisms of grooves and ridges could also be applied in any of the other embodiments described herein.

The base 36 also includes a clip 64 formed by a pair of projections 66, 68 projecting from the body 40 and arranged to define an opening 68 therebetween and a latching member 70 which is pivotally attached to an end of projection 66 defining the opening and spring-loaded or biased to engage with the end of the other projection 68 defining the opening. The latching member 70 can be depressed inward to enable access to an interior region of the carabiner 34 through the opening (as shown by the dotted lines 70a in FIG. 7) and thereby allow the carabiner 34 to be hooked onto a belt loop or another loop of material on a garment or object such as a knapsack. The projections 68, 70 can be integrally formed with the body 40 or formed separately and fixed thereto. Other constructions of projections and latching members known in the carabiner art can also be used in the invention.

Base 36 optionally includes a flange 72 with an aperture 74 therein at an end of the base 36 for attaching the base 36 (and carabiner 34 in its entirety when the cover 38 is attached to the base 36) to another object.

Another embodiment of an electronic storage device including a carabiner in accordance with the invention is shown in FIG. 9 and is designated generally as 76. The electronic storage device including a carabiner 76 is substantially similar to that shown in FIGS. 6-8 except that a clip 78 is formed on the cover 38 instead of the base 36. Thus, the clip 78 is formed by a pair of projections 80, 82 projecting from the cover 38 and arranged to define an opening 83 therebetween and a latching member 84 which is pivotally attached to an end of projection 80 defining the opening and spring-loaded or biased to engage with the end of the other projection 82 defining the opening. The projections 80, 82 can be integrally formed with the cover 38 or formed separately and fixed thereto. Other constructions of projections and latching members known in the carabiner art can also be used in the invention.

Other features of the electronic stroage device including a carabiner 76 are an indicator light 86 arranged on the base 36 which indicates the operational status of the memory device 42 and an aperture 88 formed on the base 36 to enable a string or thread to pass therethrough in order to provide an additional means for carrying the device 76. These features could also be applied to the devices 10, 34 shown in FIGS. 1-8.

As shown, device 76 does not include the mating groove 60 and ridge 62. However, the grooves 60 and ridges 62 can be provided to secure the base 36 and cover 38 together, or in the alternative, a friction fit can be provided.

One difference between the placement of the clip on the cover 38 of device 76 instead of on the base 36 of the carabiner 34, i.e., that part which includes the memory device, is that when using the device 76, it would not be necessary to remove the device 76 from the garment or other object to which it is clipped in order to access the memory device 42, but rather only the base 36 need be detached from the cover 38 while the cover 38 would remain clipped to the garment or other object.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A portable electronic storage device, comprising:
a base;
a memory device arranged in connection with said base;
an adapter connected to said memory device;
a cover detachably connected to said base, said adapter being arranged on said base such that when said cover is detached from said base, said adapter is exposed and when said cover is connected to said base, said adapter is covered by said cover; and
a clip arranged on one of said base and said cover for enabling said base or said cover to be removably clipped to an object,
wherein said clip includes first and second portions arranged to define an opening therebetween and a latching member pivotally attached to an end of said first portion defining the opening and biased to engage with an end of said second portion defining the opening.

2. The portable electronic storage device of claim 1, wherein said adapter is a USB connector.

3. The portable electronic storage device of claim 1, wherein said memory device is a memory stick having memory in the size of 16 MB, 32 MB, 64 MB, 128 MB, 256 MB, or 512 MB.

4. The portable electronic storage device of claim 1, wherein said memory device is arranged inside said base.

5. (canceled)

6. The portable electronic storage device of claim 1, wherein said clip is arranged on said base.

7. The portable electronic storage device of claim 6, wherein said base includes a main body and said clip includes first and second portions arranged to define an opening therebetween and a latching member pivotally attached to an end of said first portion defining the opening and biased to engage with an end of said second portion defining the opening, said first and second portions of said clip projecting outward from said main body.

8. The portable electronic storage device of claim 1, wherein said clip is arranged on said cover.

9. The portable electronic storage device of claim 1, further comprising engagement means for mating said base and said cover while preventing unintentional separation of said base from said cover.

10. The portable electronic storage device of claim 9, wherein said engagement means comprise at least one ridge formed on said cover and at least one groove formed on said base and corresponding in size to a respective one of said at least one ridge and aligning with said respective ridge when said cover is properly connected to said base.

11. The portable electronic storage device of claim 1, wherein said base includes a flange with an aperture therein at an end of said base for enabling attachment of said base to another object.

12. The portable electronic storage device of claim 1, wherein said adapter projects outward from an edge of said base and said cover includes a cavity receivable of said adapter.

13. The portable electronic storage device of claim 1, wherein said base includes a mounting rim projecting from an edge of said base and said adapter projects from an edge of said mounting rim, said cover including a cavity receivable of said adapter and said mounting rim.

14. The portable electronic storage device of claim 13, wherein said cavity includes an interior ledge to thereby provide said cavity with a first, wider portion receivable of said mounting rim and a second, narrower portion receivable of said adapter.

15. The portable electronic storage device of claim 13, further comprising engagement means for mating said base and said cover while preventing unintentional separation of said base from said cover.

16. The portable electronic storage device of claim 15, wherein said engagement means are arranged on said mounting rim and on an inner surface of said cover defining said cavity.

17. The portable electronic storage device of claim 16, wherein said engagement means comprise at least one ridge formed on said inner surface of said cover defining said cavity and at least one groove formed on said mounting rim and corresponding in size to a respective one of said at least one ridge and aligning with said respective ridge when said cover is properly connected to said base.

18. The portable electronic storage device of claim 1, wherein said base includes an aperture for enabling attachment of said base to another object.

19. The portable electronic storage device of claim 1, wherein said clip comprises a carabiner.
